(19) United States
(12) Patent Application Publication
(10) Pub. No.: US 2004/0044602 A1
(43) Pub. Date: Mar. 4, 2004

(54) Electronic invoice processing system with automatic adjustment feature

(76) Inventors: Lisa Christine Batur, (US); Michael Patrick Force, (US)

Correspondence Address: Grossman, Tucker, Perreault & Pfleger, PLLC, 55 South Commercial Street, Manchester, NH, 03101, US

(21) Appl. No.: 10/232,159

(22) Filed: Aug. 30, 2002

(51) Int. Cl. G06F 17/60

(52) U.S. Cl. 705/34

(57) ABSTRACT

A rules engine application for an electronic invoice processing system that automatically adjusts an electronic invoice by analyzing the electronic invoice, detecting if a rule condition associated with the invoice is violated, and adjusting the submitted total invoice to an adjusted total invoice amount if the detecting step detects the rule is violated. A machine readable medium and related electronic invoice processing systems having such a machine readable medium that stores instructions for performing such functions are also provided.

### FIELD OF THE INVENTION

The present invention relates generally to an internet-based electronic invoice processing system, and in particular to such a system having an automatic adjustment feature for automatically adjusting an invoice should an invoice be subject to an associated rule violation.

### BACKGROUND OF THE INVENTION

Various internet-based electronic invoice processing systems are known in the art whereby a vendor can electronically create and present a bill to a customer for review. Such systems may also incorporate electronic payment features. Such electronic systems have the advantage of displacing traditional paper-based billing and payment methods. As such, efficiencies can be realized for both a vendor and customer by avoiding associated manual work created by such traditional paper-based billing and processing methods.

When the vendor and customer are businesses conducting business-to-business transactions, for example, when the vendor is a law firm and the customer is a client corporation, complex billing rules are often negotiated and must be adhered to by the law firm. For instance, these rules may relate to a variety of matters including timekeeper rates and unit rates per various expense categories. The law firm should implement systems for generating its bills in compliance with the rules and the corporate client customer typically finds it useful to check each bill to assure the law firm has complied.

Some electronic invoice processing systems may have a rules engine to help users define and apply rules to select matters. If a rule is violated, a user may select certain actions for the rules engine to take. For instance, these actions may include an automatic reject action, or a flag action to provide an indicator of a rule violation to reviewers of an invoice. However, for some rule violations, it would be more advantageous to automatically adjust a particular item or invoice upon detection of such a rule violation. This would further reduce administrative costs associated with invoice preparation and processing and shorten payment cycles.

Accordingly, there is a need for a rules engine in an electronic invoice processing system having the ability to automatically adjust an invoice upon detection of an associated rule violation.

### BRIEF SUMMARY OF THE INVENTION

A method of automatically adjusting an electronic invoice consistent with the invention includes the steps of: analyzing an electronic invoice with a submitted total invoice amount; detecting if a rule associated with the invoice is violated; and adjusting the submitted total invoice amount to an adjusted total invoice amount if the detecting step detects the rule is violated.

A machine readable medium consistent with the invention, whose contents cause a computer server system to perform a method of automatically adjusting an electronic invoice, wherein the method includes the steps of: analyzing an electronic invoice with a submitted total invoice amount; detecting if a rule associated with the invoice is violated; and adjusting the submitted total invoice amount to an adjusted total invoice amount if the detecting step detects the rule is violated.

An electronic billing system consistent with the invention includes: a data center configured to receive an electronic invoice with a submitted total amount, the data center comprising a datacenter computer server and a machine readable medium whose contents cause the data center computer system to perform a method of automatically adjusting the electronic invoice, the method including the steps of detecting if a rule associated with the electronic invoice is violated; and adjusting the submitted total invoice amount to an adjusted total invoice amount if the detecting step detects the rule is violated.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a block diagram of an electronic invoice processing system consistent with the invention;

FIG. 2 is an exemplary screen display that a customer may see to select an automatic adjustment feature consistent with the invention;

FIG. 3 is a flow chart of an exemplary process for automatically adjusting a submitted invoice amount to an adjusted invoice amount if an associated rule condition is violated;

FIG. 4 is a flow chart of an exemplary process for automatically adjusting a line item of an invoice if an associated rule condition is violated; and

FIG. 5 is an exemplary rules table for use with the process of FIG. 4.

### DETAILED DESCRIPTION

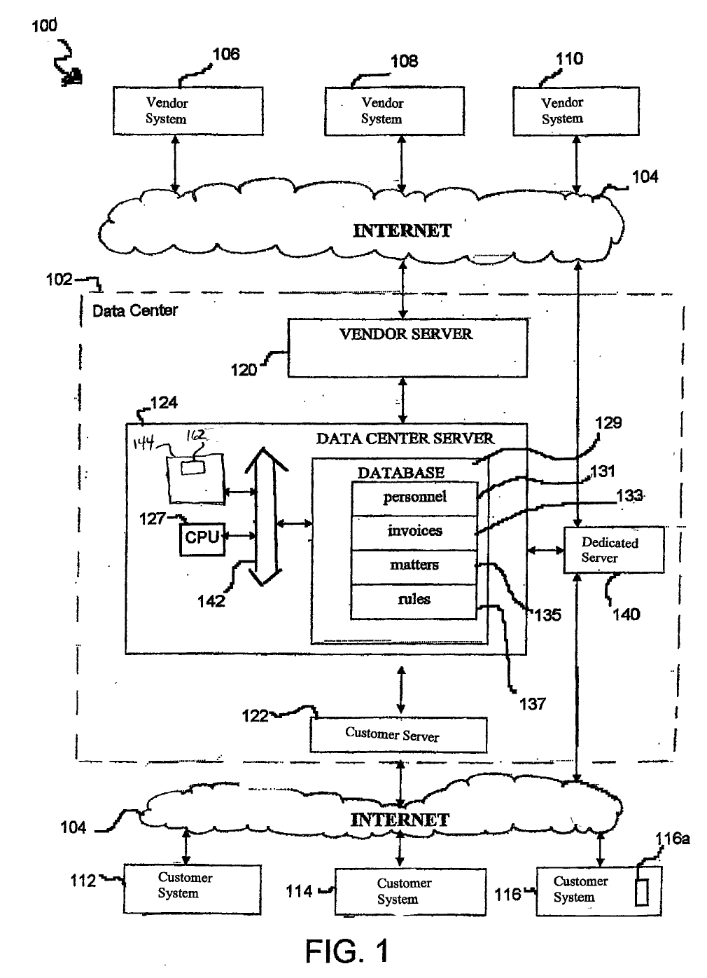

FIG. 1 illustrates a web-based electronic invoice processing system 100 consistent with the invention. In general, the system 100 includes a data center 102 coupled via the internet 104 to various vendor systems 106,108, 110 and customer systems 112,114, 116. The data center 102 serves as a centralized repository for storing, managing, and processing data related to invoice generation, analysis, and payment as further detailed herein. The data center 102 includes a vendor server 120, a customer server 122, a data center server 124, and a dedicated server 140. In one of many embodiments, the system 100 may be used as a legal e-billing system enabling a plurality of law firms (vendor systems) and their client corporations (customer systems) to engage in electronic invoice processing and payment.

In general, the system 100 permits vendor systems 106, 108, 110 to present invoices, in electronic form, to various customer systems 112, 114, 116, and allows customer systems 112, 114, 116 to automate a number of invoice review and processing operations as detailed further herein.

The vendor systems 106, 108, 110 and customer systems 112, 114, 116 represent parties that participate in the system 100. Each party may have one or more computer workstations having appropriate hardware and browser software, e.g., Netscape Navigator ™ or Microsoft Internet Explorer ™, and/or direct real-time Transmission Control Protocol/Internet Protocol (TCP/IP), for permitting human users to send and receive data to the data center 102 and to control various operations of the data center 102 in real time and/or batch type transactions. To provide secure transmissions over the internet 104, the browser software should preferably have a minimum 128-bit encryption capability. As such, all files, e.g., invoice files, matter files, and timekeeper files, are encrypted when they are sent over the internet 104 to an associated server 120, 122.

Each vendor system 106, 108, 110 or customer system 112, 114, 116 may also have one or more associated servers, e.g., server 116a for customer system 116, that run associated applications. For instance, each vendor system 106, 108,110 may have any one of a plurality of time and billing software systems, and each customer system 112, 114,116 may have any one of a plurality of matter management systems or accounts payable systems.

In order to communicate and integrate with such outside systems of each vendor system and customer system, the system 100 may be further equipped with a dedicated server 140 that is configured to transfer and receive data to and from associated servers of vendors or customers using a predetermined communication protocol. For example, such a server 140 may be a File Transfer Protocol (FTP) server that can exchange files using FTP protocol to an associated server of any vendor systems 106,108, 110 or customer systems 112, 114, 116.

For example, server 116a of customer system 116 may transfer matter management data from its matter management system to the server 140. The data center server 124 may then later accept such data for use it any of its processes. The data center server 124 may also transfer data, e.g., invoice data, to the server 140 so that the server 140 can later communicate such data to the accounts payable system of customer system 116 via server 116a. As such, the server 140 provides a way to integrate the data center 102 with disparate systems of any vendor or customer.

The vendor server 120 and customer server 122 are illustrated and described herein as separate server software applications operated on separate hardware systems for clarity of description. Those skilled in the art will recognize however, that such functionality for each could be combined on one server application or in multiple server applications operating on a single hardware system. Access to the servers 120,122 by the vendor systems 106, 108, 110 and customer systems 112,114, 116 may be through a variety of communication channels over the internet 104 such as point-to-point leased line/frame relay, public internet via an internet service provider, or a virtual private network (VPN) to name a few.

In addition, data transfers between vendor systems 106, 108, 110 and customer systems 112,114,116 to the data center server 124 may use a predetermined communication protocol as well so that the data content of the files is recognized by the data center server 124 and the “associated application” at the vendor systems 106,108, 110 or customer systems 112, 114, 116. For instance, in transferring invoice data from a vendor system 106, 108, 110 to the data center 102 a standard format such as the LEDES™ electronic invoice standard coordinated by PriceWaterhouseCoopers may be utilized.

The vendor server 120 is a software application that provides services to other client software applications in a client/server relationship. In one instance, the vendor server 120 provides services to the vendor systems 106, 108,110. In another instance, the vendor server 120 acts as a client in making requests to the data center server 124 which fulfills such requests. For instance, the data center server 124 may provide view matter, review invoices, and submit invoice transactions to the vendor server 120. The vendor server 120 builds a Hypertext Markup Language (HTML) or other graphical user interface (GUI) document in accordance therewith. A GUI document is then provided to the vendor system 106, 108, 110 which displays various GUI documents. Such GUI documents enable the user to perform a variety of functions such as viewing matters assigned to them, reviewing invoices, and submiting invoices and timekeepers.

Similar to the vendor server 120, the customer server 122 is a software application that provides services to other client software applications in a client/server relationship. In one instance, the customer server 122 provides services to the customer systems 112, 114, 116. In another instance, the customer server 122 acts as a client in making requests to the data center server 124 which fulfills such requests. The customer server 122 builds an HTML or other GUI document in accordance with such request. A GUI document is then provided to the customer system 112, 114, 116 which displays such documents. Such GUI documents enable a customer user to perform a variety of functions such as reviewing invoices, and creating billing rules for such invoices.

The data center server 124 of the data center 102 includes a processor 127 which operates data center server applications 125 that performs the main processing operations for the system 100. The data base server 124 also includes an extensive database 129 that contains aggregations of data records. Such data records relate to vendor systems 106, 108, 110, customer systems 112, 114, 116, and associated information. The database 129 is a relational database such as a DB2 database from IBM Corporation that can manage the large volumes of data to be stored and processed by the data center server 124. A standard user and application program interface to such a relational database is structured query language (SQL).

For clarity of description, some of the related aggregated data categories in the relational database are described herein as “data modules.” Some of the data modules include a personnel data module 131, an invoices data module 133, a matters data module 135, and rules data module 137 to name several. In general, the personnel data module contains information about personnel of the customers 116, 118, 120 who are able to act upon invoices. The invoices data module 133 contains invoice related data submitted by the various vendors. The matters data module 135 contains basic information to identify and describe various matters. Finally, the rules data module 137 contains data relating to any rules defined by any customer 112, 114, 116. Each of these data modules may be implemented in one or more related database tables.

The rules engine 162 is one of the software applications 125 that is stored on a machine readable media 144 of the data center server 124. This rules engine 162 performs functions that enable a user of the customer system 112, 114, 116 to create specific rules and store relevant data for such rules in the rules data module 137 that may then be later applied to particular customer-vendor relationships.

For instance, the data center server applications 125 including the rules engine 162 are software routines that may be stored on any variety of machine readable media 144 for execution by the CPU 127. The processor 127 of the data center server 124 can be any type of processor capable of providing the speed and functionality required by embodiments of the invention. For example, the processor could be a processor from the Pentium® family of processors made by Intel Corporation.

The machine-readable media 144 can be any type of media capable of storing instructions adapted to be executed by the processor 162. Some examples of such media include, but are not limited to, system RAM, read only memory (ROM), programmable ROM, magnetic disk (e.g., floppy disk and hard disk drive), optical disk (e.g., CD/DVD ROM), and any other device that can store digital information. As used herein, the phrase “adapted to be executed by a processor” is meant to encompass instructions stored in compressed and/or encrypted format, as well as instructions that have to be compiled or installed by an installer before being executed by the processor. The processor 127 and machine-readable media 144 may be part of various components of the data center 102 and data center server 124 where various combinations of machine-readable media may store combinations of the rules engine software which are accessible by the processor through various controllers.

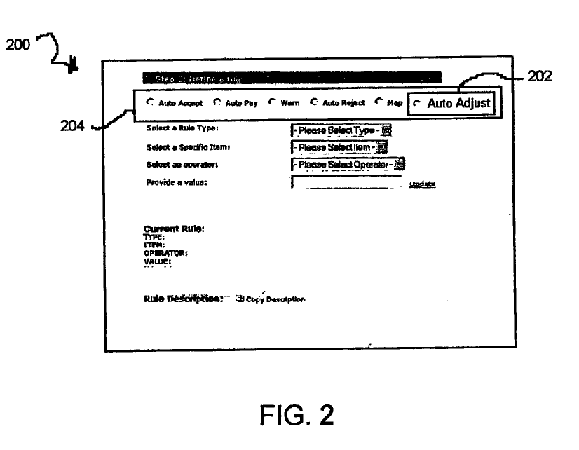

Advantageously, a rules engine application 162 consistent with the invention is configured to give a customer a choice of an “automatic adjustment” action. For instance, the rules engine 162 communicates with the vendor server 122 so that the vendor server can create an exemplary graphical user interface (GUI) 200 visible to the user as illustrated in FIG. 2. Advantageously, the rules engine application 162 prompts the user to choose one of a plurality of actions 204 when defining a rule, where one of the actions is an “automatic adjustment” action 202. If a user selects this action 202, the rules engine application 162 will automatically adjust the particular invoice and/or line item if a violation condition for such a rule is detected.

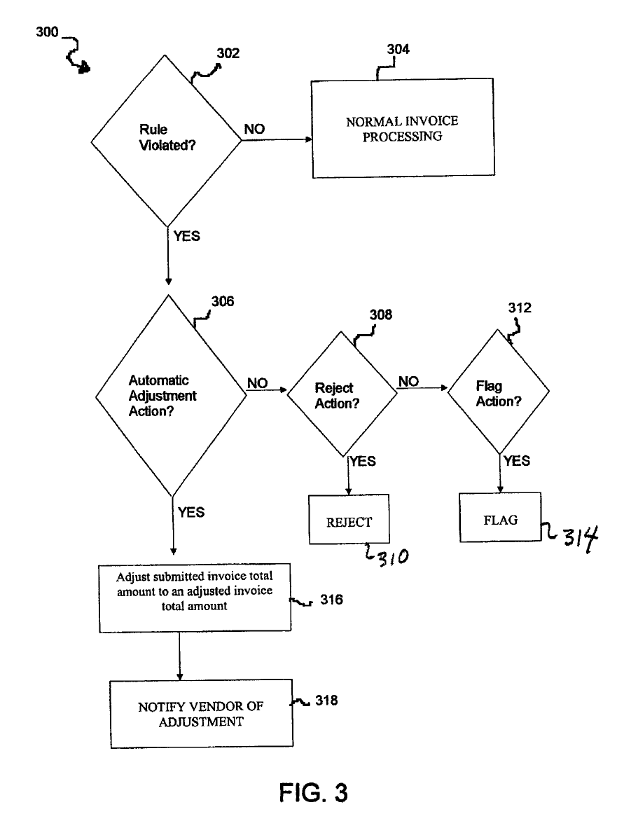

Turning to FIG. 3, an exemplary flow chart 300 illustrating the functionality of a rules engine 162 having an automatic adjustment feature for adjusting a submitted invoice total amount to an adjusted invoice total amount is illustrated. The rules engine 162 first checks a particular invoice to determine if a rule was violated. This may occur in a variety of ways known by those skilled in the art. One way is that the rules engine 162 compares appropriate fields of invoice data submitted by a particular vendor 106, 108, 110 as referenced in an invoices data module 133 of the database 129 with any corresponding fields of a rule referenced in the rules data module 137.

If no rules violation is detected, normal invoice processing steps would continue 304. If a rule violation was detected, the rule engine 162 would then determine if the automatic adjustment action was selected by the particular customer 306. If it was not selected, then the rules engine 162 would determine if the automatic reject action 308 was selected or the flag action 312 was selected and take the appropriate action (reject 310 or flag 314) as appropriate. For simplicity, other actions are not illustrated.

If the automatic adjustment action was selected by the customer, the rules engine 162 would adjust the submitted invoice total amount to an adjusted invoice total amount in step 316. Although not necessary, the rules engine 162 may then notify an appropriate vendor of the adjustment 318. For example, a rule defined by a customer may indicate that a total monthly invoice for a particular matter number should not exceed $20,000 and to automatically adjust such invoice down to this amount if the rule violation (total invoice amount exceeding $20,000) is detected.

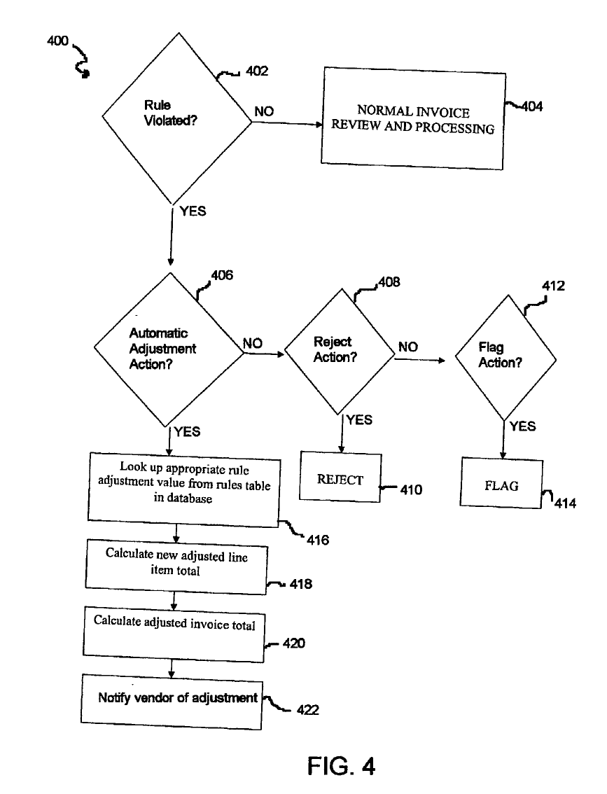

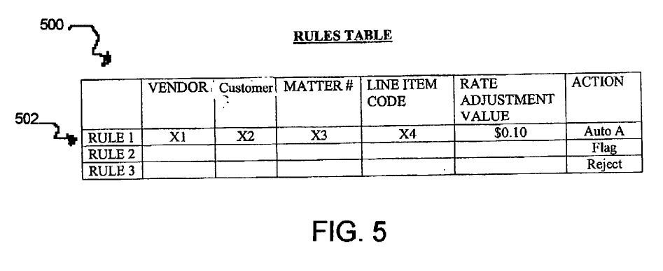

Turning to FIG. 4 in conjunction with FIG. 5, an exemplary flow chart 400 and table 500 illustrating application of an automatic adjustment feature to adjust a particular line item of an invoice is illustrated. Description of any similar steps as previously described with reference to FIG. 3 is omitted herein for clarity.

In the process 400 of FIG. 4, a customer has utilized the rules engine 162 application to create a rule that applies to a particular line item and has selected the automatic adjustment action in case that rule is violated. Upon creation of such a rule, the rules engine 162 inserts pertinent data into an appropriate table, e.g., a rule table 500, of the database 129. For instance, FIG. 5 illustrates a simplified table 500 to which a row of data 502 may be added when a rule is created. This new row 502 generally includes information related to the new rule. For instance, details on a particular vendor (code x1), customer (code x2), and matter number (code x3) are typically specified. In addition, the particular line item (code x4) to which the rule applies is also stored. The selected Action to take is an automatic adjustment action consistent with the invention, and the trigger point for such action is if the unit price for the selected line item exceeds $0.10 per unit.

Turning to FIG. 4, an exemplary flow chart 400 illustrating the functionality of a rules engine 162 having an automatic adjustment feature for adjusting a line item of an invoice is illustrated. If the rules engine 162 detects the rule was violated in step 402 and the automatic adjustment feature action was selected 406, the rules engine 162 would look up the rate adjustment value 416 (e.g., $0.10 in the exemplary rules table 500), and use that value to calculate an adjusted line item total 418. The adjusted line item total would then be used to calculate an adjusted invoice total 420. As with the process of FIG. 3, an appropriate vendor may be notified of the adjustment 422.

For example, the exemplary rule stored in the table 500 of FIG. 5 indicates to automatically adjust any per unit charges for line item code x4, e.g., copying charges per page, to $0.10 per page if this rule is violated. Therefore, if a vendor inadvertently charged $0.15 per unit for 1,000 units for a line item total of $150, the rules engine having an automatic adjustment feature would automatically calculate an adjusted line item total to be $100 and then further recalculate the invoice total as well. Notice of the adjustment may then be electronically communicated to the appropriate vendor or vendors informing them of the change.

The embodiments that have been described herein, however, are but some of the several which utilize this invention and are set forth here by way of illustration but not of limitation. It is obvious that many other embodiments, which will be readily apparent to those skilled in the art, may be made without departing materially from the spirit and scope of the invention as defined in the appended claims.

What is claimed is:

1. A method of automatically adjusting an electronic invoice comprising the steps of:
analyzing an electronic invoice with a submitted total invoice amount;
detecting if a rule associated with said invoice is violated; and
adjusting said submitted total invoice amount to an adjusted total invoice amount if said detecting step detects said rule is violated.

2. The method of claim 1, further comprising the step of:
notifying a customer associated with said electronic invoice that said submitted total invoice amount has been adjusted to said adjusted total invoice amount.

3. The method of claim 1, wherein said rule comprises an appropriate rule adjustment value, and said adjusting step utilizes said rule adjustment value to calculate said adjusted total invoice amount.

4. The method of claim 3, wherein said rule adjustment value applies to a line item of said invoice.

5. The method of claim 4, wherein said rule adjustment value is a cost per unit value for said line item.

6. The method of claim 3, wherein said rule adjustment value applies to said submitted total invoice amount.

7. A machine readable medium whose contents cause a computer server system to perform a method of automatically adjusting an electronic invoice, said method comprising:
analyzing an electronic invoice with a submitted total invoice amount;
detecting if a rule associated with said invoice is violated; and
adjusting said submitted total invoice amount to an adjusted total invoice amount if said detecting step detects said rule is violated.

8. The machine readable medium of claim 7, further comprising the step of:
notifying a vendor associated with said electronic invoice of said adjusting step.

9. The machine readable medium of claim 7, wherein said rule comprises an appropriate rule adjustment value, and said adjusting step utilizes said rule adjustment value to calculate said adjusted total invoice amount.

10. The machine readable medium of claim 9, wherein said rule adjustment value applies to a line item of said invoice.

11. The machine readable medium of claim 10, wherein said rule adjustment value is a cost per unit value for said line item.

12. The machine readable medium of claim 9, wherein said rule adjustment value applies to said submitted total invoice amount.

13. An electronic billing system comprising:
a data center configured to receive an electronic invoice with a submitted total amount, said data center comprising a datacenter computer server and a machine readable medium whose contents cause said data center computer system to perform a method of automatically adjusting said electronic invoice, said method comprising:
detecting if a rule associated with said electronic invoice is violated; and
adjusting said submitted total invoice amount to an adjusted total invoice amount if said detecting step detects said rule is violated.

14. The system of claim 13, wherein said method further comprises the step of:
notifying a vendor of said adjusting step.

15. The system of claim 13, wherein said rule comprises an appropriate rule adjustment value, and said adjusting step utilizes said rule adjustment value to calculate said adjusted total invoice amount.

16. The system of claim 15, wherein said rule adjustment value applies to a line item of said invoice.

17. The system of claim 16, wherein said rule adjustment value is a cost per unit value for said line item.

18. The system of claim 15, wherein said rule adjustment value applies to said submitted total invoice amount.
